(19) United States
(12) Patent Application Publication
(10) Pub. No.: US 2024/0416538 A1
(43) Pub. Date: Dec. 19, 2024

(54) SCISSOR ASSEMBLY WITH QUANTIFIED FINGER RESTS

(71) Applicant: EVERSHARP PRO COMPANY, Taichung City (TW)

(72) Inventor: Shao Peng Chang, Taichung City (TW)

(73) Assignee: EVERSHARP PRO COMPANY, Taichung City (TW)

(21) Appl. No.: 18/733,051

(22) Filed: Jun. 4, 2024

(30) Foreign Application Priority Data
Jun. 14, 2023 (TW) 112206002

(51) Int. Cl. B26B 13/20

(52) U.S. Cl. CPC B26B 13/20

(57) ABSTRACT

A scissor assembly with quantified finger rests has a pair of scissors and multiple finger rests. The multiple finger rests have different weights and are interchangeably mounted to the pair of scissors. Each one of the multiple finger rests has a finger rest body and a weight indicating unit. The weight indicating unit is disposed on the finger rest body for distinguishing the finger rest and the other finger rests. In use, a user can identify each one of the multiple finger rests and pick a finger rest with a required weight from the multiple finger rests to be mounted to the pair of scissors according to the user's habit of holding a pair of scissors, which improves the comfortability in use of the scissor assembly.

### BACKGROUND OF THE INVENTION

### 1. Field of the Invention

The present invention relates to scissors, and particularly to a scissor assembly with quantified finger rests.

### 2. Description of Related Art

Scissors, e.g. hair scissors, may have a finger rest disposed on an edge of one of two finger rings. The finger rest functions as a counterweight to produce a torque against a torque produced by blades, which allows the scissors to achieve torque equilibrium easier and improves comfort in use.

A conventional scissor assembly has a pair of scissors and multiple finger rests. The pair of scissors has a connecting portion for mounting one of the multiple finger rests thereon. The multiple finger rests may have different colors or contours, which allows a user to choose a finger rest according to appearance. However, the multiple finger rests in the conventional scissor assembly are only distinguishable by appearances. For different users or different working situations, the conventional scissor assembly fails to provide an appropriate finger rest as a suitable counterweight, and hence the comfort in use still has room for improvement.

To overcome the shortcomings of the conventional scissor assembly, the present invention provides a scissor assembly with quantified finger rests to mitigate or obviate the aforementioned problems.

### SUMMARY OF THE INVENTION

The main objective of the present invention is to provide a scissor assembly with quantified finger rests that has multiple finger rests having different weights, allows a user to identify each one of the multiple finger rests and choose according to the user's requirement, and thus quantifies comfort in use.

The scissor assembly with quantified finger rests has a pair of scissors and multiple finger rests. The multiple finger rests have different weights and are interchangeably mounted to the pair of scissors. Each one of the multiple finger rests has a finger rest body and a weight indicating unit. The weight indicating unit is disposed on the finger rest body for distinguishing said finger rest and other said finger rests.

Other objectives, advantages and novel features of the invention will become more apparent from the following detailed description when taken in conjunction with the accompanying drawings.

### BRIEF DESCRIPTION OF THE DRAWINGS

FIG. 1 is an exploded view of a first preferred embodiment of a scissor assembly with quantified finger rests in accordance with the present invention;

FIG. 2 is a perspective view of the scissor assembly with quantified finger rests in FIG. 1 mounted with one of multiple finger rests;

FIG. 3 is an enlarged front side view in partial section of the scissor assembly with quantified finger rests in FIG. 2;

FIG. 4 is an operational view of the scissor assembly with quantified finger rests in FIG. 2;

FIG. 5 is a perspective view of the scissor assembly with quantified finger rests in FIG. 1 mounted with another one of the multiple finger rests;

FIG. 6 is an operational view of the scissor assembly with quantified finger rests in FIG. 5; and

FIG. 7 is an exploded view of a second preferred embodiment of the scissor assembly with quantified finger rests in accordance with the present invention.

### DETAILED DESCRIPTION OF THE PREFERRED EMBODIMENT

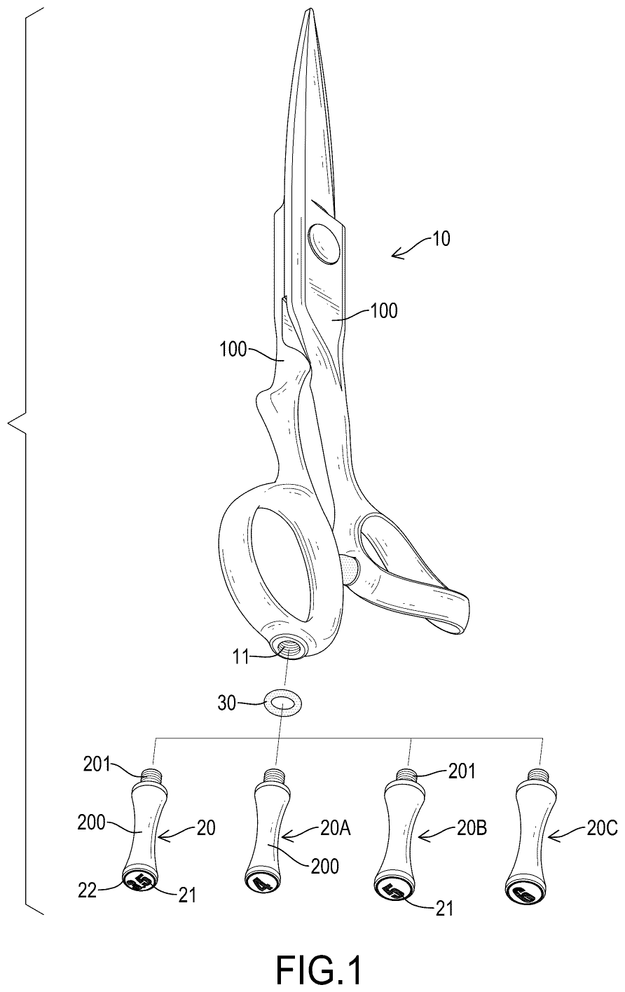

With reference to FIG. 1, a first preferred embodiment of a scissor assembly with quantified finger rests in accordance with the present invention has a pair of scissors 10 and multiple finger rests. In the first preferred embodiment, the scissor assembly has four said finger rests in total, and the four said finger rests are respectively a first finger rest 20, a second finger rest 20A, a third finger rest 20B, and a fourth finger rest 20C. The multiple finger rests are interchangeably mounted to a bottom end of one of two finger rings of the pair of scissors 10; i.e., one of the multiple finger rests is mounted to the pair of scissors 10 at a time.

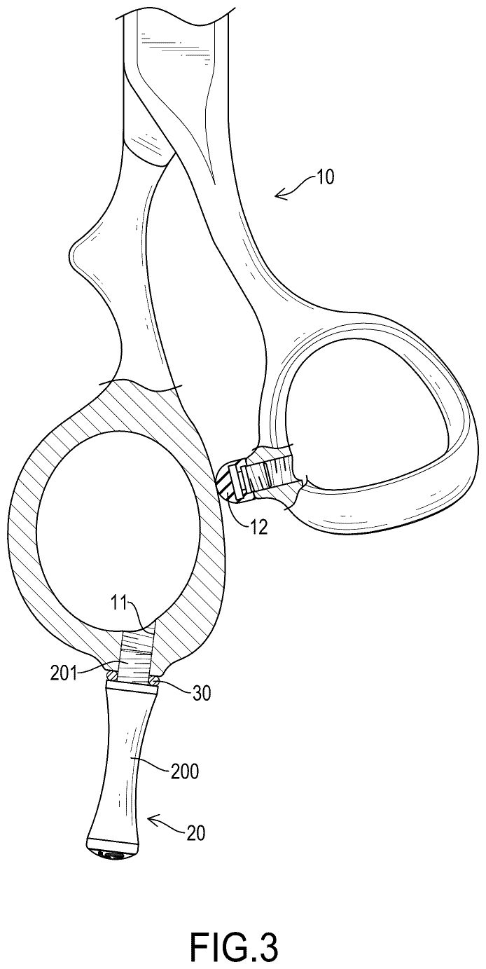

Specifically, with reference to FIGS. 1 and 3, the pair of scissors 10 has a first connecting portion 11 being a threaded hole, and each one of the multiple finger rests has a second connecting portion 201 being a threaded rod portion. The second connecting portion 201 is located on a top end of said finger rest and is configured to be screwed with the first connecting portion 11. In other embodiments, the first connecting portion 11 on the pair of scissors 10 may be a threaded rod portion with the second connecting portion 201 on each finger rest being a threaded hole.

With reference to FIGS. 1, 2, and 5, each one of the multiple finger rests has a finger rest body 200 and a weight indicating unit 21. The second connecting portion 201 is connected to a top end of the finger rest body 200, and the weight indicating unit 21 is disposed on the finger rest body 200. The multiple finger rests have different weights, and the weight indicating unit 21 allows the corresponding finger rest to be distinguished from other said finger rests for a user to identify each one of the multiple finger rests.

In the first preferred embodiment, the weight indicating unit 21 has a contour of an Arabic Numeral that shows the weight of the corresponding finger rest. Specifically, the first finger rest 20 is about 3.5 grams; the second finger rest 20A is about 4 grams; the third finger rest 20B is about 5 grams; the fourth finger rest 20C is about 6 grams. Correspondingly, the contour of the weight indicating unit 21 on the first finger rest 20 shows Arabic Numeral “3.5”; the contour of the weight indicating unit 21 on the second finger rest 20A shows Arabic Numeral “4”; the contour of the weight indicating unit 21 on the third finger rest 20B shows Arabic Numeral “5”; the contour of the weight indicating unit 21 on the fourth finger rest 20C shows Arabic Numeral “6”. Further, in the first preferred embodiment, the weight indicating unit 21 includes at least one notch formed on the finger rest body 200 by processing.

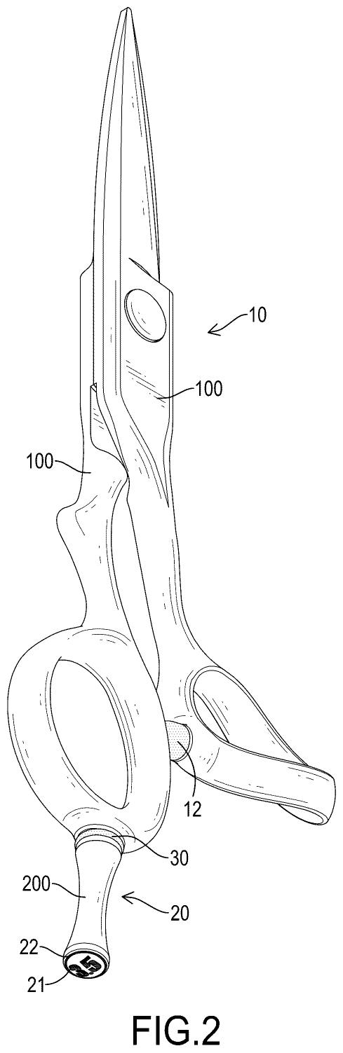

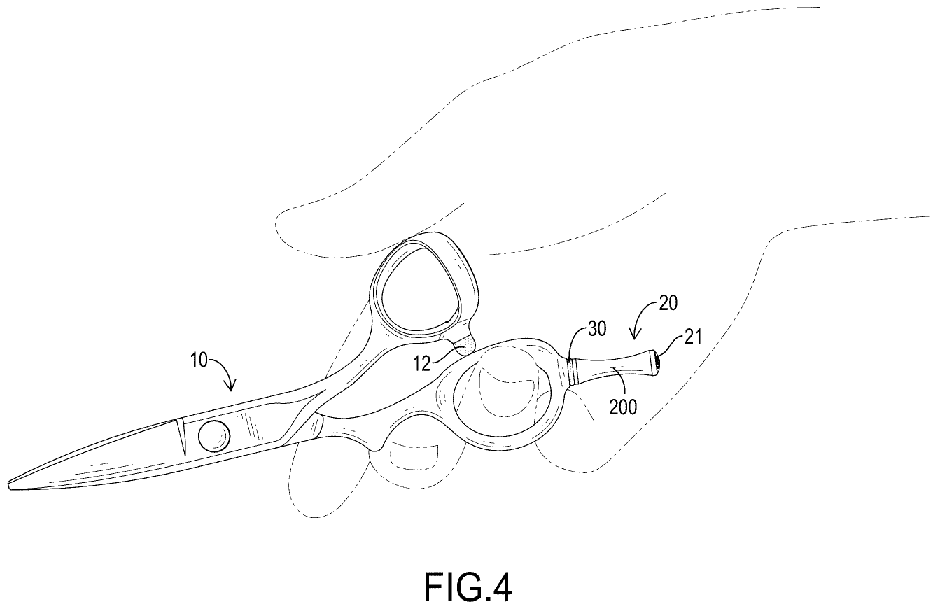

In use of the scissor assembly, a user may first pick the lightest first finger rest 20 out of the four finger rests. When picking the first finger rest 20, the user can identify which finger rest is the first finger rest 20 according to the weight indicating unit 21, pick the first finger rest 20 from the multiple finger rests stored together, and then mount the first finger rest 20 to the pair of scissors as shown in FIG. 2. With reference to FIG. 4, when holding the pair of scissors 10 with the first finger rest 20, the middle finger of the user can be regarded as a fulcrum of a total torque system. To achieve equilibrium of torque, a sum of a torque applied by the user and a torque produced by the first finger rest 20 should be equal to a torque produced by blade portions of the pair of scissors 10 such that the user can stably hold the pair of scissors 10 with the first finger rest 20.

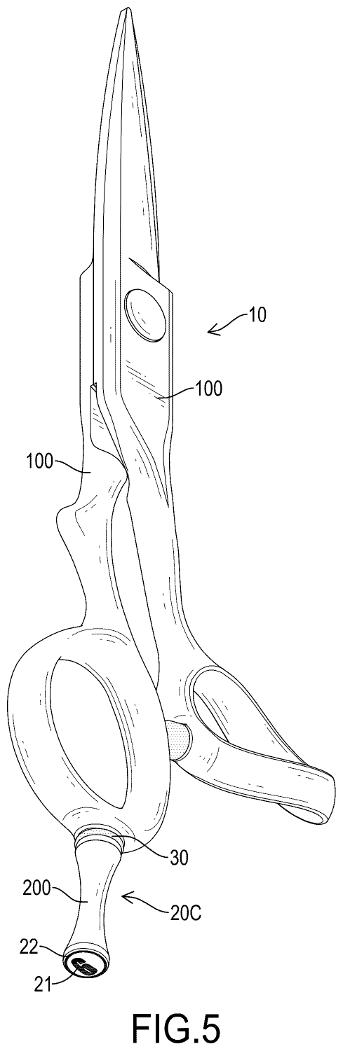

Next, the user may replace said finger rest when needed. When replacing said finger rest, the user first detaches the first finger rest 20 from the pair of scissors 10 and then mounts another said finger rest onto the pair of scissors 10. E.g., the first finger rest 20 can be replaced with the heaviest fourth finger rest 20C. The user can identify which finger rest is the fourth finger rest 20C according to the weight indicating unit 21, pick the fourth finger rest 20C from the multiple finger rests stored together, and then mounts the fourth finger rest 20C onto the pair of scissors 10 as shown in FIG. 5.

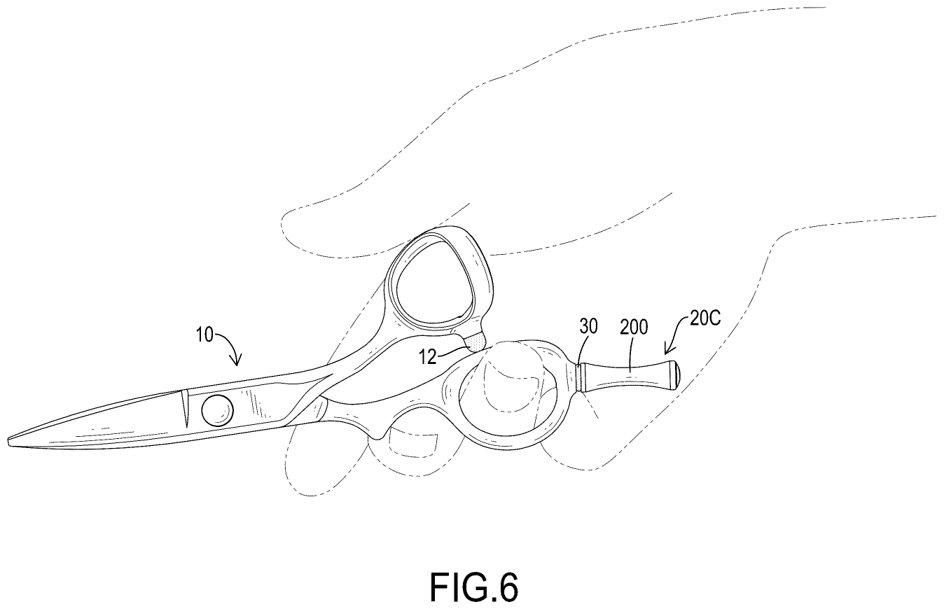

With reference to FIG. 6, when holding the pair of scissors 10 with the fourth finger rest 20C, the middle finger of the user is also regarded as the fulcrum of the total torque system. To achieve equilibrium of torque, a sum of the torque applied by the user and a torque produced by the fourth finger rest 20C should be equal to the torque produced by the blade portions of the pair of scissors 10 such that the user can stably hold the pair of scissors 10 with the fourth finger rest 20C. Since the fourth finger rest 20C is heavier than the first finger rest 20, the torque produced by the fourth finger rest 20C is greater. The user only needs to apply a lower torque to stably hold the pair of scissors 10 with the fourth finger rest 20C.

With the configurations above, the scissor assembly with quantified finger rests has multiple finger rests having different weights, and each one of the multiple finger rests has the weight indicating unit 21 to be distinguished from other finger rests with different weights. Thereby, the scissor assembly May quantify the comfortability in use via the multiple finger rests with different weights. When the scissor assembly is used by different users, each user can identify each finger rest via the weight indicating unit 21 and then pick the required finger rest with a specific weight according to his/her habit of applying force, holding position, or others when holding a pair of scissors to increase the comfort in use.

With reference to FIGS. 1, 2, and 5, in the first preferred embodiment, each one of the multiple finger rests further has a color indicating unit 22. The color indicating unit 22 is disposed on the finger rest body 200, and said color indicating units 22 of the multiple finger rests have different colors. By the color indicating units 22 of the multiple finger rests in different colors, the recognizability of each one of the multiple finger rests can further be improved, which also improves convenience of the user picking a required finger rest from the multiple finger rests.

Furthermore, in the first preferred embodiment, the color indicating unit 22 is annular and surrounds the weight indicating unit 21. By the color indicating unit 22 surrounding the weight indicating unit 21 to accentuate the weight indicating unit 21, the user is more likely to notice the weight indicating unit 21. Moreover, the color indicating unit 22 and the weight indicating unit 21 on each one of the multiple finger rests are in a same color, which not only keeps the consistency on appearance to improve aesthetic but also connects the weight indicating unit 21 with the corresponding color to allow the user to distinguish the multiple finger rests via different colors. The recognizability may also be improved.

In the first preferred embodiment, a recess (notch) is first formed on the finger rest body 200 by processing, and the color indicating unit 22 is formed by painting the recess (notch), gluing a patch with color on the recess (notch), or adopting other coloring means on the recess (notch). Also, the weight indicating unit 21 can be colored by the same process mentioned above.

In the first preferred embodiment, the second connecting portion 201 of each one of the multiple finger rests is configured to be screwed with the first connecting portion 11 of the pair of scissors 10. In other embodiments, the second connecting portion 201 and the first connecting portion 11 may be connected to each other via a mortise and tenon joint or an extra fastener. The connecting means between each one of the multiple finger rests and the pair of scissors 10 is not limited to the first preferred embodiment.

Additionally, the scissor assembly further has a washer 30. When the second connecting portion 201 is screwed with the first connecting portion 11, the washer 30 is disposed between and abuts the pair of scissors 10 and said finger rest, which prevents abrasion of said finger rest due to friction between said finger rest and the pair of scissors 10, prevents said finger rest from lightening due to abrasion, and prevents the comfortability of holding the pair of scissors 10 from being interfered by the lightening finger rest.

With reference to FIG. 1, each one of the multiple finger rests has two opposite ends respectively being a top end and a bottom end. A diameter of each one of the multiple finger rests tapers from the two opposite ends of said finger rest toward a middle of said finger rest; i.e., the middle of said finger rest is concave inward, which allows the user to place his/her little finger on the middle of said finger rest. The second connecting portion 201 is located on the top end of said finger rest, and the bottom end of said finger rest forms a convex surface. The weight indicating unit 21 and the color indicating unit 22 are disposed on the convex surface, which is convenient for the user to check said finger rest picked by the user when screwing the second connecting portion 201 with the first connecting portion 11.

With reference to FIGS. 3, 5, and 6, in the first preferred embodiment, the pair of scissors 10 further has a silencer 12 connected to one of the two finger rings of the pair of scissors 10. When the two finger rings of the pair of scissors 10 approach each other, the silencer 12 first abuts against the other one of the two finger rings, which eliminates the sound caused by the collision between the two finger rings. The blade portions are still able to close even if an obstruction is located between the two finger rings when the silencer 12 abuts against said finger ring. Specifically, the silencer 12 is made of a soft material to function as a cushion and is screwed with the corresponding finger ring.

In the first preferred embodiment, as described above, the weight indicating unit 21 of each one of the multiple finger rests includes at least one notch on the finger rest body 200. In other embodiments, the weight indicating unit 21 may be at least one protrusion formed by processing, a marking directly painted on the finger rest body 200, or a patch directly glued on the finger rest body 200; the weight indicating unit 21 still allows said finger rest to be distinguished from other said finger rests with different weights. The weight indicating unit 21 in the first preferred embodiment including at least one notch avoids the problem of the patch peeling off and the marking fading out.

As described above, in the first preferred embodiment, the weight indicating unit 21 has the contour of Arabic Numeral corresponding to the weight of said finger rest. In other embodiments, the weight indicating unit 21 may have the contour of Roman Numeral or Chinese Numeral, or include different numbers of recessed points, linear indentations, protruding points, or linear protrusions. As long as the weight indicating unit 21 allows the corresponding finger rest to be distinguished from other finger rests, the configuration of the weight indicating unit 21 is not limited to the first preferred embodiment.

Moreover, in the first preferred embodiment, the scissor assembly has the fourth finger rests respectively being 3.5 grams, 4 grams, 5 grams, and 6 grams in weight. In other embodiments, number and weights of the multiple finger rests can be decided according to different requirements. E.g., if said finger rests with greater weights are needed, the finger rests can be made of metal having higher density (such as lead). The configuration of the multiple finger rests is not limited to the first preferred embodiment.

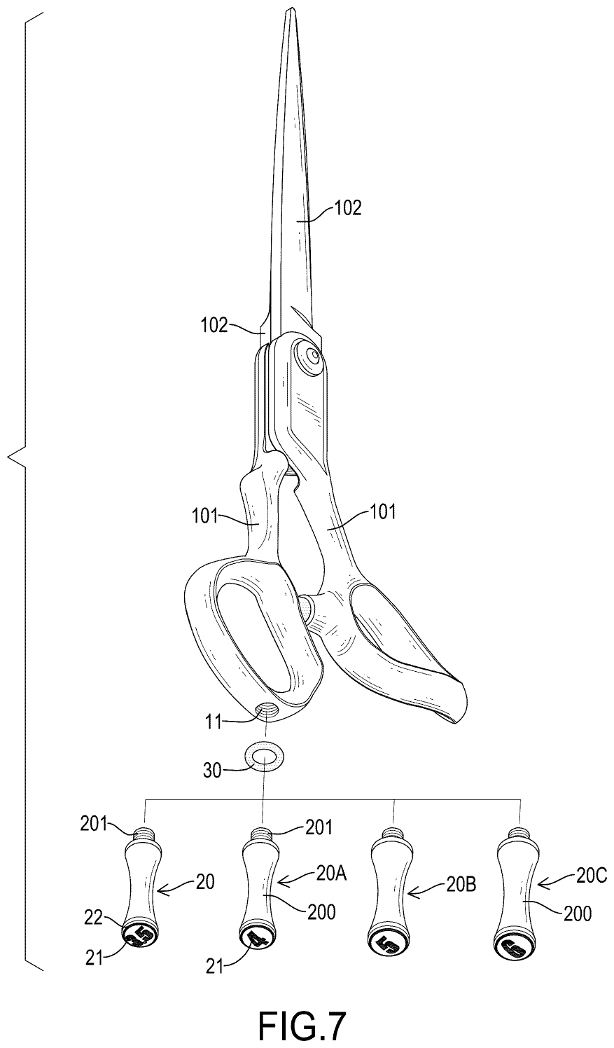

With reference to FIG. 7, a second preferred embodiment in accordance with the present invention differing from the first preferred embodiment is shown. With reference to FIG. 1, in the first preferred embodiment, the pair of scissors is composed of two blade bodies 100, and each one of the two blade bodies has a finger ring portion and a blade portion formed in one piece; with reference to FIG. 7, in the second preferred embodiment, the pair of scissors 10 is composed of two finger ring units 101 and two blade units 102; i.e., the blades and the finger rings of the pair of scissors 10 are individually manufactured. The finger ring units 101 may be made of non-metal material. In other embodiments, the scissor assembly may adopt different configurations of scissors. As long as the scissor assembly has the multiple finger rests having different weights, and each one of the multiple finger rests has the weight indicating unit 21 to be distinguished from other said finger rests, the present invention increases the comfortability in use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A scissor assembly with quantified finger rests comprising:
a pair of scissors; and
multiple finger rests having different weights and interchangeably mounted to the pair of scissors, each one of the multiple finger rests having
a finger rest body; and
a weight indicating unit disposed on the finger rest body for distinguishing said finger rest and other said finger rests.

2. The scissor assembly with quantified finger rests as claimed in claim 1, wherein
each one of the multiple finger rests has a color indicating unit disposed on the finger rest body; and
said color indicating units of the multiple finger rests are in different colors.

3. The scissor assembly with quantified finger rests as claimed in claim 2, wherein
the color indicating unit and the weight indicating unit of said finger rest are in a same color; and
the color indicating unit is annular and surrounds the weight indicating unit.

4. The scissor assembly with quantified finger rests as claimed in claim 1, wherein
the pair of scissors has a first connecting portion;
each one of the multiple finger rests has a second connecting portion located on one of two opposite ends of said finger rest and configured to be screwed with the first connecting portion; and
the scissor assembly has a washer disposed between and abutting against the pair of scissors and a respective one of the multiple finger rests when the second connecting portion of the corresponding finger rest is screwed with the first connecting portion.

5. The scissor assembly with quantified finger rests as claimed in claim 1, wherein
each one of the multiple finger rests has two opposite ends; and
a diameter of each one of the multiple finger rests tapers from the two opposite ends of said finger rest toward a middle of said finger rest.

6. The scissor assembly with quantified finger rests as claimed in claim 2, wherein
each one of the multiple finger rests has two opposite ends; and
a diameter of each one of the multiple finger rests tapers from the two opposite ends of said finger rest toward a middle of said finger rest.

7. The scissor assembly with quantified finger rests as claimed in claim 3, wherein
each one of the multiple finger rests has two opposite ends; and
a diameter of each one of the multiple finger rests tapers from the two opposite ends of said finger rest toward a middle of said finger rest.

8. The scissor assembly with quantified finger rests as claimed in claim 4, wherein a diameter of each one of the multiple finger rests tapers from the two opposite ends of said finger rest toward a middle of said finger rest.

9. The scissor assembly with quantified finger rests as claimed in claim 1, wherein
each one of the multiple finger rests has two opposite ends;
one of the two opposite ends of said finger rest located away from the pair of scissors when said finger rest is mounted to the pair of scissors forms a convex surface; and
the weight indicating unit is disposed on the convex surface.

10. The scissor assembly with quantified finger rests as claimed in claim 2, wherein
each one of the multiple finger rests has two opposite ends;
one of the two opposite ends of said finger rest located away from the pair of scissors when said finger rest is mounted to the pair of scissors forms a convex surface; and
the weight indicating unit is disposed on the convex surface.

11. The scissor assembly with quantified finger rests as claimed in claim 3, wherein
each one of the multiple finger rests has two opposite ends;
one of the two opposite ends of said finger rest located away from the pair of scissors when said finger rest is mounted to the pair of scissors forms a convex surface; and
the weight indicating unit is disposed on the convex surface.

12. The scissor assembly with quantified finger rests as claimed in claim 4, wherein
one of the two opposite ends of said finger rest located away from the pair of scissors when said finger rest is mounted to the pair of scissors forms a convex surface; and
the weight indicating unit is disposed on the convex surface.
